(19) United States
(12) Patent Application Publication
(10) Pub. No.: US 2009/0319463 A1
(43) Pub. Date: Dec. 24, 2009

(54) Color Scheme and Style Controller System

(76) Inventors: Martin L. Shoemaker, Hopkins, MI (US); Robert B. Karmes, Delton, MI (US); Andrew W. Stampor, Portage, MI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/394,488

(22) Filed: Feb. 27, 2009

Related U.S. Application Data
(60) Provisional application No. 61/074,275, filed on Jun. 20, 2008.

(51) Int. Cl. G06N 5/02; G06F 3/048

(52) U.S. Cl. 706/47; 715/763

(57) ABSTRACT

A presenter and a style controller are provided that can be used to create a graphical user interface that have uniform characteristics throughout an application. The graphical user interface can be made from various controls that includes rules for various characteristics. The controls can include a button, a list, and text controls for the graphical interface that contain rules for various characteristics, such as font color, font size, foreground color and background color, and others. This way a graphical user interface can be worked on by any number of designers but still maintain uniform characteristics throughout the application.

### CROSS-REFERENCE TO RELATED APPLICATIONS

This application claims priority to provisional U.S. patent application entitled, “Color Scheme and Style Controller System,” filed Jun. 20, 2008, having a Ser. No. 61/074,275, now pending, the disclosure of which is hereby incorporated by reference in its entirety.

### FIELD OF THE INVENTION

The present invention relates generally to development of graphical user interface (GUI). More particularly, the present invention relates to a system and method that generates customized GUI.

### BACKGROUND OF THE INVENTION

A graphical user interface (GUI) is used on various computing devices ranging from vehicle diagnostic devices to smart phones to MP3 players to personal computers. The GUI includes characteristics such as font type, font size, font color, border colors of a window, background and foreground colors and other characteristics. During development, various GUIs can have text, menus, pages, buttons that need to be designed and the design team will have various designers working the various GUIs used by a program or software. Additionally, the program can be designed to be used by various clients and these clients require certain customized “look and feel” to their programs including font style, font colors and potentially their own logos embedded in the GUI. Given these challenges and that designers are hired on a project to project basis, they may not know the requirements of the various clients and thus, a review of the GUIs must be made after they are designed in order to make them compliant to the clients' specifications. The review of each GUI takes time and effort and thus, makes the program development more costly than it needs to be.

Thus, there is a need for a design system that allows for efficient design of GUIs that can be easily customized, as needed, based on various “rules” outlined by the clients or preferred by the designer.

### SUMMARY OF THE INVENTION

The foregoing needs are met, to a great extent, by the present invention, wherein in one aspect a system is provided that in some embodiments allows designers to provide uniform or customized GUIs.

The foregoing needs are met, to a great extent, by one or more embodiments of the present invention. According to one such embodiment, a system for generating a graphical user interface for a program is provided, which can inclede a presenter that compile rules to generate a form that becomes the graphical user interface on a display of a computing device, and a controller that interacts with a control having rules that allows the presenter to generate the information on the form based on predetermined characteristics.

In accordance with another embodiment of the present invention, a system for generating a graphical user interface for a program is provided, which can include a means for presenting configured to compile rules to generate a form that becomes the graphical user interface on a display of a computing device, and a means for interacting configured to interact with a control having rules that allows the means for presenting to generate the information on the form based on predetermined characteristics.

In accordance with another embodiment of the present invention, a method of generating a graphical user interface for a display on a computing device, which can select a new screen to create the graphical user interface, activate a presenter, select a current control with the presenter, obtain a control type with the presenter, look up a control type in an aggregator applicator, apply the current control with the presenter if the control type is found, and show the form by the presenter.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates an example of a GUI used in a computing device, such as a vehicle diagnostic tool.

FIG. 2 illustrates the various components of a controller system according to an embodiment of the invention.

FIG. 3 is a diagram displaying the interactions between the application and the Colors Style Controller.

FIG. 4 is a diagram displaying the interactions between the application, the Colors Style Controller and Table of IApplicators.

FIG. 5 is a diagram displaying the interactions between the application, the presenter, the control, the Table of IApplicators and the IApplicator.

### DETAILED DESCRIPTION

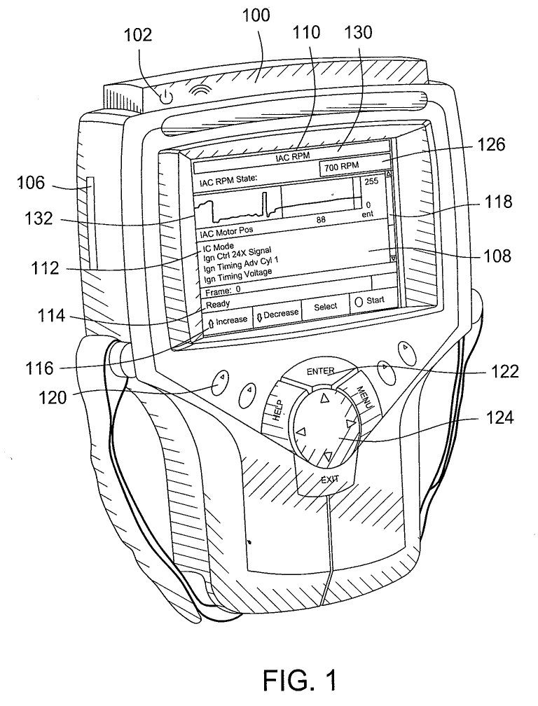

The invention will now be described with reference to the drawing figures, in which like reference numerals refer to like parts throughout. FIG. 1 illustrates an example of a GUI 110 used in a computing device, such as a vehicle diagnostic tool 100. The diagnostic tool 100 includes a power button 102, a media reader 106, a display 108 having GUI 110, and input device that includes a series of functional buttons 120 and buttons 122 and a directional disc 124. The power button 102 turns the diagnostic tool on and off or puts it into a standby mode.

The media reader allows for external media such as a compact disc (CD), DVD (digital video disc), flash memory (compact flash, secure digital, memory stick, etc.), PC cards and similar media to be inserted into the diagnostic tool 100. This allows for additional functionality to the diagnostic tool 100. Updates to programs or the programs can be stored in these various media for use by the diagnostic tool 100. Additionally, information can be stored, received, and transmitted depending on the type of external media.

The input device allows the user to manipulate information on the GUI, such as selecting a test to run on the tool from a menu or pushing a button on the GUI. The functional buttons 120 can be preprogrammed for a particular function, such as pushing a button on a screen or bringing up a particular program on the diagnostic tool 100. The buttons 122 can also perform such function as “help,” “enter,” “menu,” “exit,” or other function as desired. The directional disc allows for directional movement of a cursor or highlighting on the GUI in order to select or deselect, scroll and other functions.

The GUI 110 can include various portions, such as title menu 130 having a color such as blue and located on a top portion of the GUI, a background color (white), a list of items 112 in a particular font characteristics (color black, Times New Roman, size 10) and located in a certain position (bottom or top half of the screen), a status screen 114 have a certain sized window, a background color (white) and font having characteristics (color, size and type). The GUI can also have a set of GUI buttons 116 located along a bottom portion (can also be along the side or top or middle) of the GUI having a background color (gray) and contain a font having characteristics (color, size and type) and symbols such as arrows or a circle (green). Additionally, the GUI can have a graphical portion 132 having a color background (blue) and table thereon having a different color and other characteristics such as font, a readout window 126 having a certain size window, with white background and font having characteristics (color, size and type) and a scroll portion 118 to scroll the information on the GUI.

As shown above, the example portions of the GUI can have varying characteristics that various developers working on the program may not be aware of and thus once the various GUIs are pieced together, the GUIs may not be uniform or developed to the clients' specifications. The colors, positions and other characteristics described herein are but examples, and are not meant to be limiting.

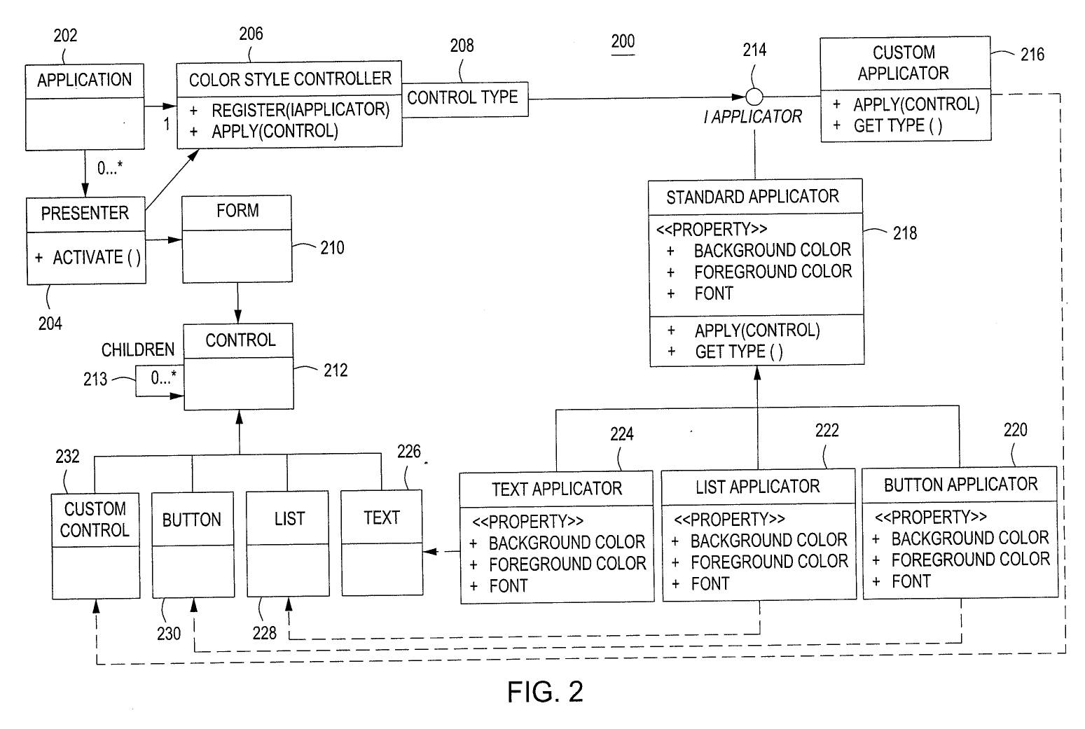

FIG. 2 illustrates the various components of a controller system 200 according to an embodiment of the invention. The controller system 200 can be used in any application 202 having a GUI, such as DTII (SPX-Service Solutions), Excel (Microsoft), Itunes (Apple) and Word (Microsoft) in order to create the GUIs needed for such applications. The system 200 includes a presenter 204, however, more than one presenter is typically used in an application due to the many GUIs associated with the application. The presenter 204 is configured to know the information to be displayed on the GUI or a form 210 (discussed below). The information can include font size, font color, font type, color background, fore background, lists and other information. One presenter 204 is used to generate each form 210. In other embodiments, one presenter 204 can generate two or more forms 210. The activate portion when activated by the presenter 204 shows the form 210. The presenter 204 is associated with the application, the form 210, and a Color Style Controller 206 (discussed below).

Form 210 is the GUI utilized in the application 202. There can be as many form 210 as needed in the application. The form 210 is made up of various controls 212, such as a button 230, a list 228, a text 226 and a custom control 232. The controls are components that make up the form 210. The control 212 is also configured to ensure that any child controls 213 that are part of other forms are following the appropriate rules for that control. For example, if there are two forms being used by the application, the control ensures that the same control (button characteristics, for example) for the first GUI will also be applied to the control for the second GUI. This ensures that all of the button characteristics are applied throughout the application or to the desired GUIs of the applications. In one embodiment, this also done “on the fly” or just before the GUI is actually viewed so that processing power is saved and that the changes are not made immediately to every GUI whether it is actually displayed or not.

The button 230, list 228, text 226 and custom control 232 are generated by various applicators, such as a text applicator 224, a list applicator 222, a button applicator 220 and a custom applicator 216, respectively. These are but examples of potential controls and applicators for the system 200 and are not meant to be limiting. The text applicator 224 may contain various properties rules for the text shown on the GUI, such as background color, foreground color, font size, font color, font type, location on the GUI and other rules. The list applicator 222 may also contain various properties rules for the list shown on the GUI, such as background color, foreground color, and font size, font color, font type, location on the GUI and other rules. Similarly, the button applicator 220 may contain various properties rules for the button shown on the GUI, such as background color, foreground color, font size, font color, font type, location on the GUI and other rules. Finally, the custom applicator 216 may contain various properties rules for the custom control, which can be any characteristics on the GUI desired by the user, such as a data window showing the various test data being received from a vehicle under test or other rules. The characteristics of the customized controls can include color of the actual received data, color of the normal range data points for that data, the font of the received data, the font of the normal range data and other characteristics.

The custom applicator 216 can have similar controls used by the standard applicator 218 or can have its own customized controls. The custom applicator 216 and the standard applicator 218 also include an apply function to apply the control and its associated rules and a get function to retrieve the custom controls or standard controls needed by the custom applicator 216 or the standard applicator 218, respectively. There can be more than one custom applicator 216 and one standard applicator 218 used in the system for a particular application 202.

As shown in FIG. 2, the text applicator 224, list applicator 222, and button applicator 220 can form the standard applicator 218. These applicators provide the rules used to provide uniformity in the forms 210. The standard applicator 218 will collect the rules from the various applicators in order to provide the uniformity for the particular form. The rules can include background color, foreground color, font and any other properties desired. As stated above, the standard applicator 218 also includes an apply function to apply the control and its associated rules and a get function to retrieve the proper control needed by the standard applicator.

The custom applicator 216 and standard applicator 218 can communicate with the IApplicator 214 or an aggregator applicator. The IApplicator 214 acts as an interface and functions to retrieve the appropriate applicator or applicators including the standard and custom applicators required by the Color Style Controller 206. There can be more than one IApplicator 214 in the system. In one embodiment, the IApplicator 214 is associated with only one applicator. The IApplicator 214 communicates with the control type 208 of the Color Style Controller 206.

The Color Style Controller 206 includes a register of various IApplicators 214 that are available in the system and the apply function that applies the appropriate control. The control type 208 has a look up table of the various IApplicators 214 available in the system and then interacts with the appropriate IApplicators 214 needed by the Color Style Controller 206.

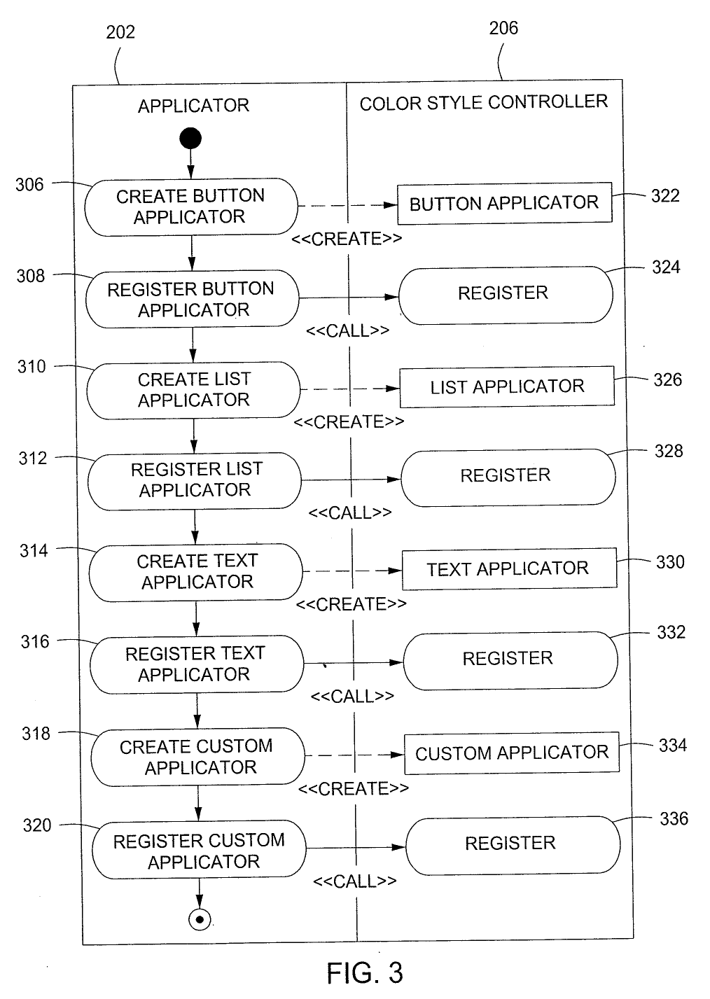

FIG. 3 is a diagram displaying the interactions between the application 202 and the Colors Style Controller 206. The application 202 starts by requesting to create a button applicator 306. The button applicator 322 can then be created. A register button applicator 308 can create a register 324 that will be associated with the button applicator 322. The application 202 can then create a list applicator 310 that creates the list applicator 326. A register list applicator 312 can create a register 328 that will be associated with the list applicator 326.

The application 202 can also create a text applicator 314 that creates the text applicator 330. A register text applicator 316 can create a register 332 that will be associated with the text applicator 330. The application 202 can also create a custom applicator 318 that creates the custom applicator 334. A register custom applicator 320 can create a register 336 that will be associated with the custom applicator 334. It should be noted that the application 202 can create the applicators in any order and any number of applicators as desired.

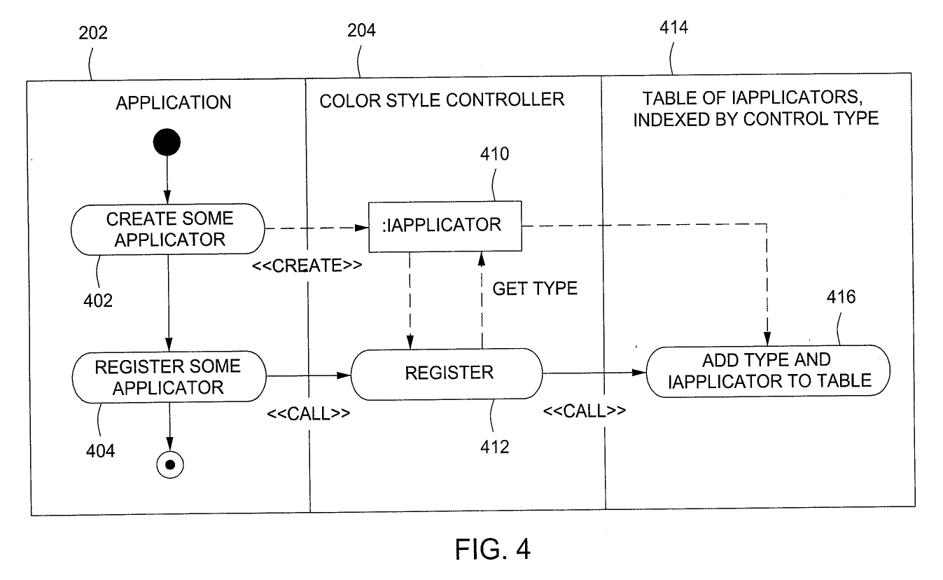

FIG. 4 is a diagram displaying the interactions between the application 202, the Colors Style Controller 206 and Table of IApplicators 414. FIG. 4 illustrates that Color Style Controller's register functions. The Table of IApplicators 414 is indexed by control type. The application 202 can create “some” applicator 402. “Some” used herein is meant to be as an a generic example that could represent a “button,” “list,” “text,” etc. as shown in FIG. 3. The IApplicator 410 is created. The application also creates the register for some applicator 404 and creates the register 412. The register 412 interacts with the IApplicator 410 to get type (button, list, etc.) in order to associate it with the IApplicator 410. Then the IApplicator 410 and type are added to the Table of IApplicators 414 for later use to produce the form.

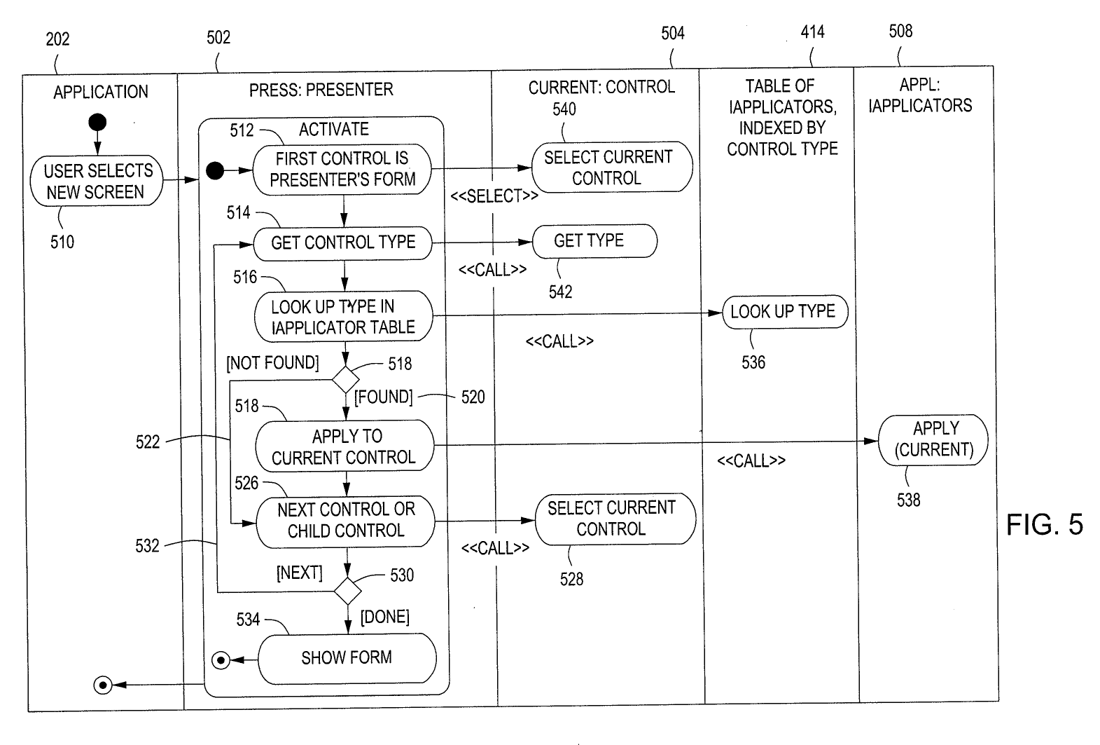

FIG. 5 is a diagram displaying the interactions between the application 202, the presenter 502, the control 504, the Table of IApplicators 414 and the IApplicator 508. For the application 202, the user selects new screen to create the GUI 510. The presenter 502 is activated and the first control is the presenter's form at step 512. The control 504 has the current control and the presenter 502 selects the current control at step 540 that it will work with at this time. The presenter 502 then gets the control type at step 514 from get type 542. Then the presenter looks up type in the IApplicator Table at step 516 and goes to look up type 536 in the Table of IApplicators 414. Again, the IApplicators is indexed by control type. If type is found 520 at step 518, then proceed to apply the current control at step 524 which can apply the current at step 538 via the IApplicator 508. Then at step 526, the next control or child control is applied. However, if at step 518, no type is found then proceed to step 526. At this point, then the next step 528 is to select the current control. At step 530, the next step can be to show form 534 as the GUI including the children, if any, is completed or can proceed back to step 514 if child control for the child GUI is needed.

As explained above, the system described herein allows for various contractors to work on various GUIs for a program with out the extensive training needed to ensure that the GUIs are uniform or confirm to previously established rules once connected together. This allows companies to hire different developers at lower costs and still have the ability to make the GUIs conform to the established rules.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system for generating a graphical user interface for a program, comprising:
a presenter that compile rules to generate a form that becomes the graphical user interface on a display of a computing device; and
a controller that interacts with a control having rules that allows the presenter to generate the information on the form based on predetermined characteristics.

2. The system of claim 1, wherein the control further comprises:
a button control that is generated by a button applicator;
a list control that is generated by a list applicator; and
a text control that is generated by a text applicator.

3. The system of claim 2, wherein the control further comprises a custom control that is generated by a custom applicator.

4. The system of claim 2, wherein the button applicator, the list applicator and the text applicator collectively form a standard applicator.

5. The system of claim 4, wherein the standard applicator provides uniformity to the form.

6. The system of claim 4, wherein an aggregator applicator is linked with the standard applicator and interfaces with the controller to retrieve the appropriate standard applicator for a particular form.

7. The system of claim 6, wherein the aggregator applicator includes a registry of standard applicator and a registry of custom applicator.

8. The system of claim 1, wherein the control is configured to ensure that a child control of the control follow the same rules.

9. The system of claim 8, wherein the control ensure the child of the control follow the same rules on the fly only when the graphical user interface is shown on the display.

10. The system of claim 2, wherein the text control, list control and button control provide rules for background color, foreground color, and font type.

11. A system for generating a graphical user interface for a program, comprising:
a means for presenting configured to compile rules to generate a form that becomes the graphical user interface on a display of a computing device; and
a means for interacting configured to interact with a control having rules that allows the means for presenting to generate the information on the form based on predetermined characteristics.

12. The system of claim 11, wherein the control further comprises:
a button control that is generated by a button applicator;
a list control that is generated by a list applicator; and
a text control that is generated by a text applicator.

13. The system of claim 12, wherein the control further comprises a custom control that is generated by a custom applicator.

14. The system of claim 12, wherein the button applicator, the list applicator and the text applicator collectively form a standard applicator.

15. The system of claim 14, wherein the standard applicator provides uniformity to the form.

16. The system of claim 14, wherein an aggregator applicator is linked with the standard applicator and interfaces with the means for interacting to retrieve the appropriate standard applicator for a particular form.

17. The system of claim 16, wherein the aggregator applicator includes a registry of standard applicator and a registry of custom applicator.

18. The system of claim 11, wherein the control is configured to ensure that a child control of the control follow the same rules.

19. The system of claim 18, wherein the control ensure the child of the control follow the same rules on the fly only when the graphical user interface is shown on the display.

20. The system of claim 12, wherein the text control, list control and button control provide rules for background color, foreground color, and font type.

21. A method of generating a graphical user interface for a display on a computing device, comprising the steps of:
selecting a new screen to create the graphical user interface;
activating a presenter;
selecting a current control with the presenter;
obtaining a control type with the presenter;
looking up a control type in an aggregator applicator;
applying the current control with the presenter if the control type is found; and
showing the form by the presenter.
